(19) United States
(12) Patent Application Publication
(10) Pub. No.: US 2015/0266125 A1
(43) Pub. Date: Sep. 24, 2015

(54) FOOT PEDAL WITH ADVANCED CONTROLS

(71) Applicant: Lincoln Global, Inc., City of Industry, CA (US)

(72) Inventors: Edward A. Enyedy, Eastlake, OH (US); William D. Wilder, Cleveland, OH (US)

(73) Assignee: Lincoln Global, Inc., City of Industry, CA (US)

(21) Appl. No.: 14/268,045

(22) Filed: May 2, 2014

Related U.S. Application Data
(60) Provisional application No. 61/954,681, filed on Mar. 18, 2014.

(51) Int. Cl. B23K 9/09; G05G 1/38

(52) U.S. Cl. CPC B23K 9/09; G05G 1/38

(57) ABSTRACT

Systems, methods, and apparatus providing advanced controls in a foot pedal device used in arc welding. The foot pedal device is configured to interface with a welding power source and provide one or more selectable modes of operation, allowing an operator to control one or more waveform characteristics of an output welding waveform. The advanced control logic for controlling the one or more waveform characteristics resides in the foot pedal device and is responsive to a depressed position of the foot pedal device. Such a foot pedal device, having advanced controls, allows for the advanced, real-time control of the output of a simple welding power source during a welding process.

This U.S. Patent Application claims priority to U.S. provisional patent application Ser. No. 61/954,681 filed on Mar. 18, 2014, which is incorporated herein by reference in its entirety.

### TECHNICAL FIELD

Certain embodiments of the present invention relate to arc welding. More particularly, certain embodiments of the present invention relate to a foot pedal device having advanced control capability, and methods of use thereof as part of a welding system.

### BACKGROUND

Foot pedal devices are often used in certain arc welding applications (e.g., GTAW welding applications) to allow a user to control the output current from a welding power source during a welding process. The foot pedal device may have a potentiometer built in which changes a resistance value as the foot pedal device is depressed. For example, when the foot pedal device is not depressed at all, the resistance of the potentiometer may be 10 ohms. When the foot pedal device is fully depressed, the resistance of the potentiometer may be 100 ohms. Values of potentiometer resistance may change linearly, or non-linearly, between 10 ohms and 100 ohms as the foot pedal is depressed by different amounts.

A welding power source operatively connected to the foot pedal device simply senses the resistance value of the potentiometer (corresponding to the amount the foot pedal is depressed) and changes a welding output current level accordingly. For example, a 10 ohm resistance value from the foot pedal device may correspond to 10 amps of welding output current, and a 100 ohm resistance value from the foot pedal device may correspond to 100 amps of welding output current. Such a simple foot pedal device may be of limited value in some applications, and may only be compatible when used with a welding power source having significant welding output control capability.

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

In one embodiment, an advanced controls foot pedal device is provided having a user-depressible foot pedal, control circuitry, and output interface circuitry. The control circuitry is configured to generate a welding waveform control signal having one or more waveform characteristics that change with a depressed foot pedal position of the user-depressible foot pedal. The output interface circuitry is operatively connected to the control circuitry and is configured to provide a communication interface to a welding power source for transmitting the welding waveform control signal from the advanced controls foot pedal device to the welding power source. The welding waveform control signal is formulated to affect a welding output of the welding power source based on the one or more waveform characteristics. The one or more waveform characteristics may include one or more of a pulsed frequency, a peak pulsed output level, an AC balance, and AC offset, or a peak-to-background range. The advanced controls foot pedal device may include a user interface configured to allow a user to select a mode of operation from a plurality of modes of operation, wherein a mode of operation defines how one or more waveform characteristics of the welding waveform control signal changes with depressed foot pedal position. The advanced controls foot pedal device may include input interface circuitry operatively connected to the control circuitry and configured to receive input information from one or more of the depressible foot pedal or the user interface. The advanced controls foot pedal device may include a digital communication port configured to provide communication between the advanced controls foot pedal device and a personal computing device. The input interface circuitry may be configured to receive input information from the digital communication port. The output interface circuitry may be configured to provide a wireless communication interface to the welding power source. The wireless communication interface may be one of a radio frequency communication interface, an infrared communication interface, or an ultrasonic communication interface.

In one embodiment, a system is provided having a welding power source, an advanced controls foot pedal device operatively interfacing to the welding power source, and a welding tool operatively connected to the welding power source. The advanced controls foot pedal device includes a user-depressible foot pedal, control circuitry, and output interface circuitry. The control circuitry is configured to generate a welding waveform control signal having one or more waveform characteristics that change with a depressed foot pedal position of the user-depressible foot pedal. The output interface circuitry is operatively connected to the control circuitry and is configured to provide a communication interface to a welding power source for transmitting the welding waveform control signal from the advanced controls foot pedal device to the welding power source. The welding waveform control signal is formulated to affect a welding output of the welding power source based on the one or more waveform characteristics. A shape of a welding waveform current of the welding output of the welding power source may directly follow a shape of the welding waveform control signal. A shape of a welding waveform voltage of the welding output of the welding power source may directly follow a shape of the welding waveform control signal. The welding power source may include a controller configured to receive the welding waveform control signal from the advanced controls foot pedal device. The welding power source may include a wireless receiver configured to wirelessly receive the welding waveform control signal from the advanced controls foot pedal device. The advanced controls foot pedal device may be configured to command a defined ramping down of a welding waveform current of the welding output of the welding power source via the welding waveform control signal when a user completely releases the user depressible foot pedal of the advanced controls foot pedal device.

In one embodiment, a method is provided. The method includes generating a welding waveform control signal, having one or more waveform characteristics, with a foot pedal device in response to activating the foot pedal device to a first depressed foot pedal position. The method further includes outputting the welding waveform control signal from the foot pedal device to a welding power source to affect a welding output of the welding power source based on the one or more waveform characteristics. The method also includes changing at least one of the one or more waveform characteristics of the welding waveform control signal in response to activating the foot pedal device to a second depressed foot pedal position. The method may also include communicating the welding waveform control signal from the foot pedal device to the welding power source to affect the welding output of the welding power source based on the one or more changed waveform characteristics. The one or more waveform characteristics may include one or more of a pulsed frequency, a peak pulsed output level, an AC balance, and AC offset, or a peak-to-background range. The welding waveform control signal may be communicated from the foot pedal device to the welding power source wirelessly. The method may further include providing a shielding gas pre-flow functionality, where shielding gas from a gas supply is allowed to flow for a predetermined time before the welding power source starts outputting the welding output to create an arc between an electrode and a workpiece operatively connected to the welding power source. The method may also include providing a shielding gas post-flow functionality, where shielding gas from a gas supply is allowed to flow for a predetermined time after the welding power source stops outputting the welding output to cause an arc to extinguish between an electrode and a workpiece operatively connected to the welding power source.

Details of illustrated embodiments of the present invention will be more fully understood from the following description and drawings.

### BRIEF DESCRIPTION OF THE DRAWINGS

FIG. 1 illustrates a schematic diagram of a first exemplary embodiment of an arc welding system having an advanced controls foot pedal device in wired communication with a welding power source;

FIG. 2 illustrates an exemplary embodiment of the welding power source used in the system of FIG. 1, showing a plurality of control knobs and interfaces;

FIG. 3 illustrates a schematic block diagram of a portion of the system of FIG. 1, showing an exemplary embodiment of how the advanced controls foot pedal device operatively interfaces to the welding power source;

FIG. 4 illustrates a schematic diagram of a second exemplary embodiment of an arc welding system having an advanced controls foot pedal device in wireless communication with a welding power source;

FIG. 5 illustrates an exemplary embodiment of an advanced controls foot pedal device showing various input interfaces;

FIG. 6 illustrates a schematic block diagram of an exemplary embodiment of the advanced controls foot pedal device of FIG. 5;

FIG. 7 is a flowchart of an exemplary embodiment of a method of how the advanced controls foot pedal device of FIG. 5 and FIG. 6 operates when used in the system of FIG. 1 or FIG. 4;

FIG. 8 illustrates a first exemplary embodiment of a foot pedal output signal (welding waveform control signal) generated by the advanced controls foot pedal device of FIG. 5 and FIG. 6 when a depressed pedal position of the advanced controls foot pedal device is held constant over time during a first selected mode of operation;

FIG. 9 illustrates a second exemplary embodiment of a foot pedal output signal (welding waveform control signal) generated by the advanced controls foot pedal device of FIG. 5 and FIG. 6 when a depressed pedal position of the advanced controls foot pedal device is changed during a second selected mode of operation;

FIG. 10 illustrates a third exemplary embodiment of a foot pedal output signal (welding waveform control signal) generated by the advanced controls foot pedal device of FIG. 5 and FIG. 6 when a depressed pedal position of the advanced controls foot pedal device is changed during a third selected mode of operation;

FIG. 11 illustrates a fourth exemplary embodiment of a foot pedal output signal (welding waveform control signal) generated by the advanced controls foot pedal device of FIG. 5 and FIG. 6 when a depressed pedal position of the advanced controls foot pedal device is changed during a fourth selected mode of operation;

FIG. 12 illustrates a fifth exemplary embodiment of a foot pedal output signal (welding waveform control signal) generated by the advanced controls foot pedal device of FIG. 5 and FIG. 6 when a depressed pedal position of the advanced controls foot pedal device is changed during a fifth selected mode of operation; and

FIG. 13 illustrates a schematic diagram of a third exemplary embodiment of an arc welding system having an advanced controls foot pedal device, and providing pre- flow and post-flow shielding.

### DETAILED DESCRIPTION

The following are definitions of exemplary terms that may be used within the disclosure. Both singular and plural forms of all terms fall within each meaning:

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing device” or “computing device” or “processor” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk.

“Computer memory”, as used herein, refers to a storage device configured to store digital data or information which can be retrieved by a computer or processing element.

The terms “signal”, “data”, and “information” may be used interchangeably herein and may be in digital or analog form.

The term “controller” is used broadly herein and may be anything from a simple switching device, to one or more processors running computer-executable software instructions in a welding power source, to complex programmable and/or non- programmable logic circuitry.

The term “functionality” as used herein may refer to the logical actions and supporting display screens of a system implemented in software and/or hardware.

Even though various embodiments are described herein with respect to a foot pedal device, it is to be understood that, in other embodiments, the foot pedal device may take the form of a hand-held remote (or some other form factor) that is not configured to be activated by depressing a foot pedal, but which includes advanced controls as described herein. Systems, methods, and apparatus providing advanced controls in a foot pedal device used in arc welding are disclosed herein. The foot pedal device is configured to interface with a welding power source and provide one or more selectable modes of operation, allowing an operator to control one or more waveform characteristics of an output welding waveform. The advanced control logic for controlling the one or more waveform characteristics resides in the foot pedal device and is responsive to a depressed position of the foot pedal device. Such a foot pedal device, having advanced controls, allows for the advanced, real-time control of the output of a simple (i.e., low end) welding power source during a welding process. For example, a welding power source configured to provide a simple DC output level may be used for a pulsed welding process when used in conjunction with an advanced controls foot pedal (ACFP) device, in accordance with an embodiment. The ACFP device allows a user to keep the depressible foot pedal at a constant depressed position and have the ACFP output a pulsed waveform control signal or some other specialty waveform control signal having one or more waveform characteristics.

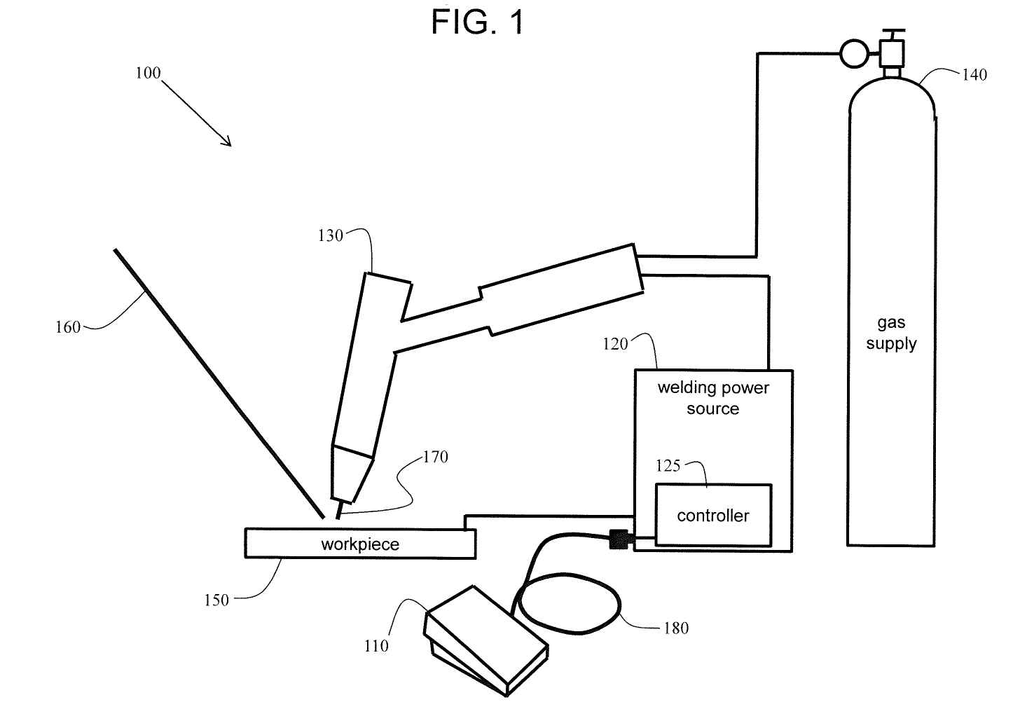

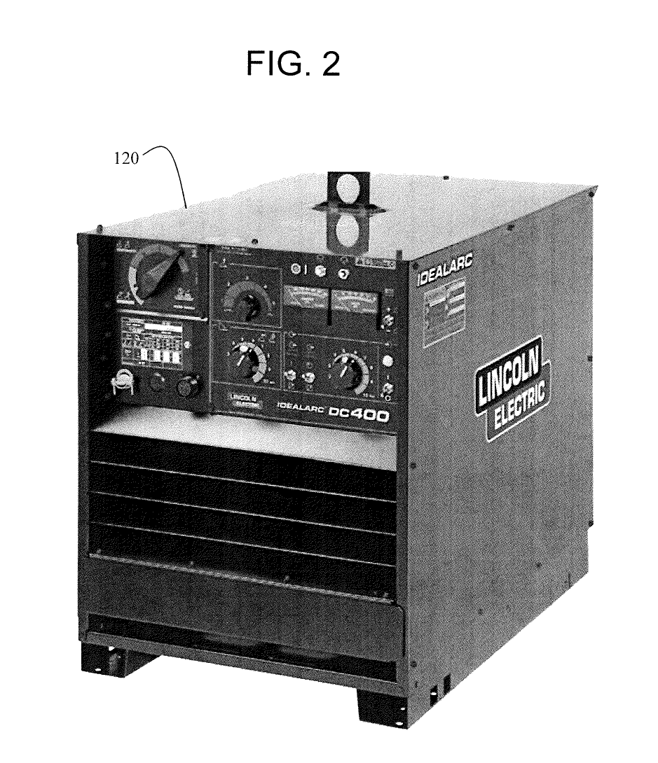

To put an example embodiment in context, FIG. 1 illustrates a schematic diagram of a first exemplary embodiment of an arc welding system 100 (e.g., a Gas Tungsten Arc Welding (GTAW or TIG) system) having an advanced controls foot pedal (ACFP) device 110 in wired communication (via a cable 180) with a welding power source 120. FIG. 2 illustrates an exemplary embodiment of the welding power source 120 used in the system of FIG. 1, showing a plurality of control knobs and interfaces. The system also includes a welding tool 130 (e.g., an electrode holder holding a non- consumable TIG welding electrode) operatively connected to the welding power source 120. The system further includes a gas supply container 140 operatively connected to the welding tool 130.

The welding power source 120 includes a controller 125 which may be simple, complex, or something in between. For example, the controller 125 may be a simple switching device, one or more processors running computer-executable software instructions, or simple or complex programmable or non-programmable logic circuitry, in accordance with different embodiments. However, advanced controls provided by the ACFP device 110 may allow even the simplest (e.g., very low end) of welding power sources to be operated in a sophisticated manner by an operator.

In one embodiment, the system 100 may be used to perform a TIG welding operation on a workpiece 150 using a filler wire 160. In such a TIG welding embodiment, a coalescence of metals (from the filler wire 160 and workpiece 150) is produced by heating the metals with an electric arc between a tungsten electrode 170 (non-consumable electrode) and the workpiece 150. Shielding of the tungsten electrode 170, the arc, and the resultant weld pool is provided by a gas (e.g., an inert gas or a mixture of inert gases) from the gas supply container 140. Other embodiments of the system 100 may be configured to perform other arc welding operations (e.g., gas metal arc welding using a consumable electrode) using the advanced controls foot pedal (ACFP) device 110.

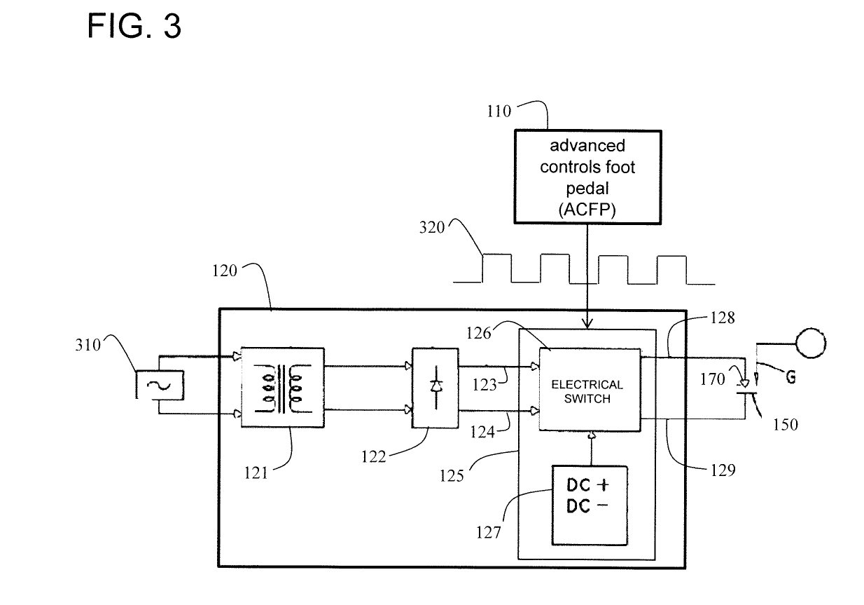

FIG. 3 illustrates a schematic block diagram of a portion of the system 100 of FIG. 1, showing an exemplary embodiment of how the advanced controls foot pedal (ACFP) device 110 operatively interfaces to the welding power source 120. The welding power source interfaces with (e.g., is plugged into) an AC electrical grid 310. The welding power source 120 includes a transformer 121 operatively connected to a rectifier 122 for creating a DC current across intermediate leads 123 and 124 directed to a controller 125 including a simple electrical switch 126 connected to a simple logic circuit 127. The electrical switch 126 provides output leads 128 and 129 connected across the electrode 170 and workpiece 150, respectively. The current of the welding process in the gap between the electrode and the workpiece is determined, at least in part, by a foot pedal output signal 320 (a.k.a., welding waveform control signal) from the ACFP device 110 to the controller 125. Characteristics of the signal 310 may be varied by an operator depressing a pedal of the ACFP device 110, for example.

As an example, referring to FIG. 2 and FIG. 3, an operator may set a control knob on the front of the welding power source 120 to a DC+ or DC− welding output current level (e.g., 75 amps DC+). The logic circuit 127 provides for the operator-selected setting of the welding output current level within the welding power source 120. The operator may then use the ACFP device 110 to send a pulsed signal 320 to the controller 125 to cause the electrical switch 126 to turn on and off, at a defined frequency, between 0 amps and the set 75 amps thereby causing the welding output current to pulse in accordance with the pulsed foot pedal output signal 320.

As the operator changes the depressed pedal position of the ACFP device 110, the frequency of pulsation may change, in accordance with an embodiment. In this manner, an adjustable pulsing capability may be provided when using a welding power source that provides no inherent pulsing capability. The ACFP device 110 may be configured to provide other signaling capabilities other than just frequency-adjustable pulsing, as described later herein with respect to other embodiments.

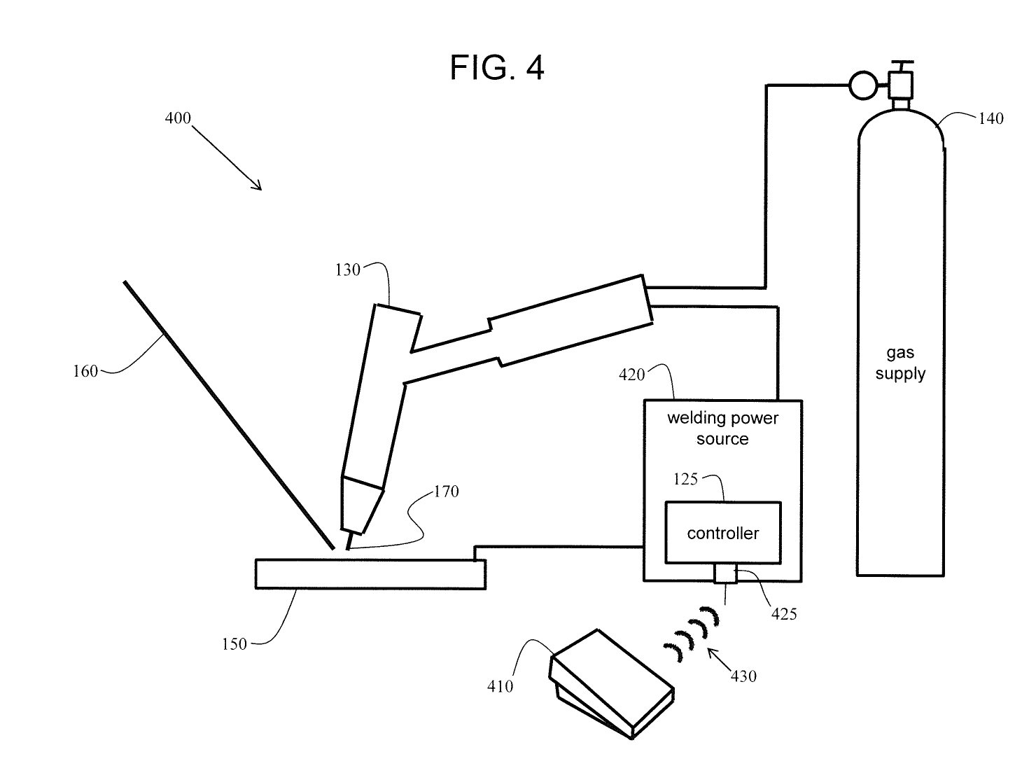

FIG. 4 illustrates a schematic diagram of a second exemplary embodiment of an arc welding system 400 having an advanced controls foot pedal (ACFP) device 410 in wireless communication with a welding power source 420. The system 400 is similar to the system 100 of FIG. 1, except that the ACFP device 410 communicates wirelessly with the welding power source 420, instead of via a cable 180. The welding power source 420 includes a wireless receiver 425 operatively connected to the controller 125 and configured to receive a wireless foot pedal output signal 430 (a.k.a., welding waveform control signal) from the ACFP device 410.

The ACFP device 410 is configured to transmit the wireless signal 430 (e.g., via a wireless transmitter). The wireless signal 430 may be a radio frequency (RF) signal generated by technologies such as, for example, Wi-Fi™, Bluetooth™, or ZigBee™, Alternatively, the wireless signal 430 may be an infrared signal, an ultrasonic signal, or some other type of signal, in accordance with various embodiments. Such a wireless ACFP device may provide more flexibility in system set up.

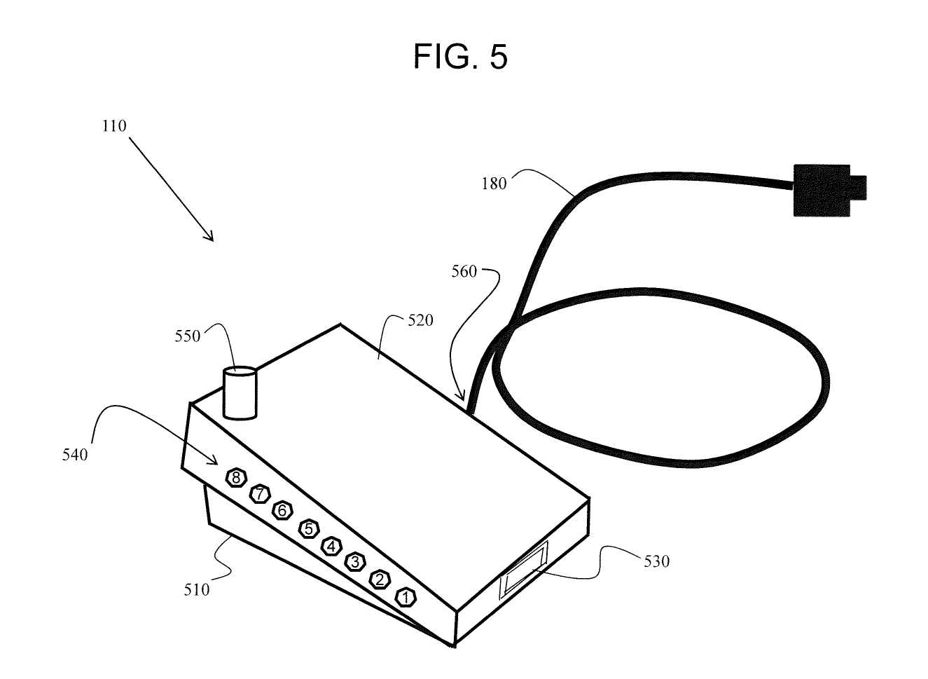

FIG. 5 illustrates an exemplary embodiment of an advanced controls foot pedal (ACFP) device 110 showing various input interfaces. The ACFP device 110 includes a base 510, a depressible foot pedal 520 (e.g., a spring-loaded foot pedal), a digital communication port (e.g., a universal serial bus (USB) port) 530, a user interface in the form of, for example, a series of push buttons or toggle switches 540, a depressible button 550, and an output port 560. One end of the cable 180 is configured to connect to the output port 560 and the other end of the cable 180 is configured to connect to an input port of a welding power source. A foot pedal output signal (welding waveform control signal) from the ACFP device 110 may be output from the output port 560 to the welding power source over the cable 180 (e.g., see FIG. 1). In accordance with an alternative embodiment, the foot pedal output signal from the ACFP device 110 is transmitted wirelessly to a welding power source.

In accordance with an embodiment, the depressible button 550 may be used to, for example, engage more cleaning action at the workpiece, even though other waveform parameters remain the same. Alternatively, the depressible foot pedal 520 may be configured to be rocked from side-to-side to engage more cleaning action at the workpiece, even though other waveform parameters remain the same. Such embodiments may require an operator to have significant foot pedal skills. In accordance with other embodiments, other effects (other than engaging more cleaning action) may be provided by the depressible button 550 or by rocking the foot pedal 520 from side-to-side.

The USB port 530 may be connected via a USB cable (not shown) to a personal computing device (not shown) to download programmed modes of operation from the personal computing device to the ACFP device 110. The various modes of operation may be selected via the series of user interface push buttons or toggle switches 540. For example, referring to FIG. 5, eight push buttons are shown on the side of the foot pedal 520. Each push button may correspond to a different mode of operation that a user (operator) can select. As an example, the first push button “1” may allow selection of a first mode of operation that provides the foot pedal output signal 320 (see FIG. 3) providing a square wave signal whose frequency may be adjustable by changing the depressed position of the foot pedal 520. The other push buttons may be configured to select other modes of operation providing other foot pedal output signals, which are discussed later herein. Alternatively, the various modes of operation may be pre-programmed or pre-implemented within the ACFP device, for example, at the factory. In such an alternative embodiment, the ACFP device may not have a USB port. In general, a mode of operation defines how one or more waveform characteristics of the welding waveform control signal changes with depressed foot pedal position.

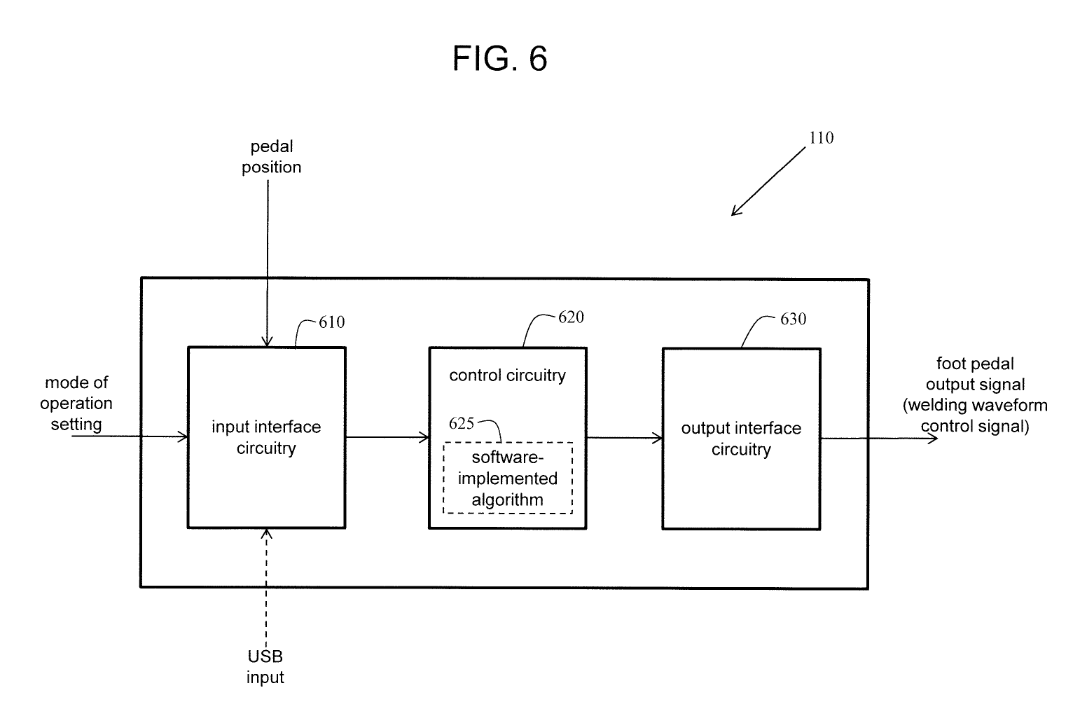

FIG. 6 illustrates a schematic block diagram of an exemplary embodiment of the advanced controls foot pedal (ACFP) device 110 of FIG. 5. The ACFP device 110 includes input interface circuitry 610, control circuitry 620, and output interface circuitry 630. The input interface circuitry 610 is configured to accept inputs corresponding to the pedal position (e.g., a potentiometer value), the setting of the modes of operation user interface (e.g., push buttons or toggle switches), and the USB input.

The control circuitry 620 is configured to accept the USB input, such as programmed data and instructions (e.g., computer-executable instructions) from the input interface circuitry 610 and store the USB input in computer memory of the control circuitry 620. The USB input and the ability to download data and software from a personal computing device may be optional. For example, the control circuitry 620 may, instead, be pre-configured (e.g., pre-programmed) at the factory such that the control circuitry does not require any further programming or configuring.

The control circuitry 620 is also configured to accept signals or data representing the selected mode of operation and the pedal position and generate signals or data representative of a foot pedal output signal. The control circuitry may be hardware controlled or software controlled, in accordance with various embodiments. For example, in one embodiment, the control circuitry may include a processing device configured to run a software-implemented algorithm 625 in the form of computer-executable instructions.

The software-implemented algorithm may operate in dependence on the selected mode of operation and the depressed foot pedal position to generate signals or data representative of a foot pedal output signal having certain welding waveform control signal characteristics. The software-implemented algorithm may be simple or complex. For example, a complex software-implemented algorithm may change multiple characteristics of a welding waveform control signal output from the foot pedal device 110, as the depressed foot pedal position is changed by an operator, to change a heat input to a weld.

The output interface circuitry 630 provides a communication interface configured to put the signals or data representative of a foot pedal output signal in a transmission format that can be communicated from the output port 560 of the ACFP device 110 to a welding power source as the actual foot pedal output signal. The transmission format of the foot pedal output signal may be an analog transmission format or a digital transmission format, in accordance with various embodiments, that is compatible with the welding power source 120. The output interface circuitry may be configured to provide a wired communication interface in one embodiment or a wireless communication interface in another embodiment. The wireless communication interface may be one of a radio frequency communication interface, an infrared communication interface, or an ultrasonic communication interface.

In accordance with one embodiment, the shape of the welding waveform output (e.g., current or voltage) of the welding power source directly follows the shape (waveform characteristics) of the welding waveform control signal from the ACFP device. In accordance with other embodiments, the shape of the welding waveform output of the welding power source does not directly follow the shape of the welding waveform control signal from the ACFP device but, instead, responds to the shape of the welding waveform control signal in an indirect manner. For example, the controller 125 of the welding power source may be configured to read or decode the shape (waveform characteristics) of the welding waveform control signal and command a shape of a welding waveform output from the welding power source that is correlated to the shape of the welding waveform control signal but in no way resembles the shape of the welding waveform control signal.

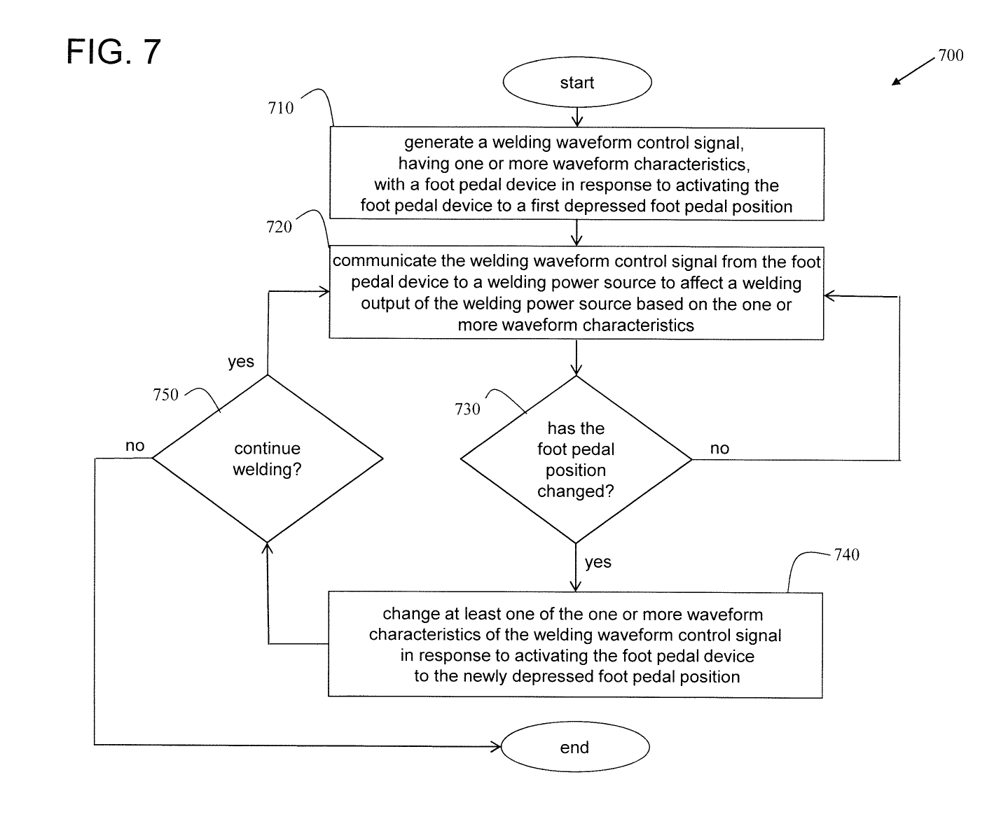

FIG. 7 is a flowchart of an exemplary embodiment of a method 700 of how the advanced controls foot pedal (ACFP) device of FIG. 5 and FIG. 6 operates when used in the system of FIG. 1 or FIG. 4. In step 710 of the method 700, generate a welding waveform control signal, having one or more waveform characteristics, with a foot pedal device in response to activating the foot pedal device to a first depressed foot pedal position. In step 720, communicate the welding waveform control signal from the foot pedal device to a welding power source to affect a welding output of the welding power source based on the one or more waveform characteristics.

In step 730, determine if the foot pedal position has changed. If the foot pedal position has not changed, go to step 720 and continue communicating the same welding waveform control signal to the welding power source. If the foot pedal position has changed, go to step 740. In step 740, change at least one of the one or more waveform characteristics of the welding waveform control signal in response to activating the foot pedal device to the newly depressed foot pedal position. In step 750, determine if welding is to continue. If welding is not to continue (e.g., if the new foot pedal position is that of being totally un-depressed), then end welding. If welding is to continue, then go to step 720 and communicate the new welding waveform control signal, having the one or more changed waveform characteristics, to the welding power source.

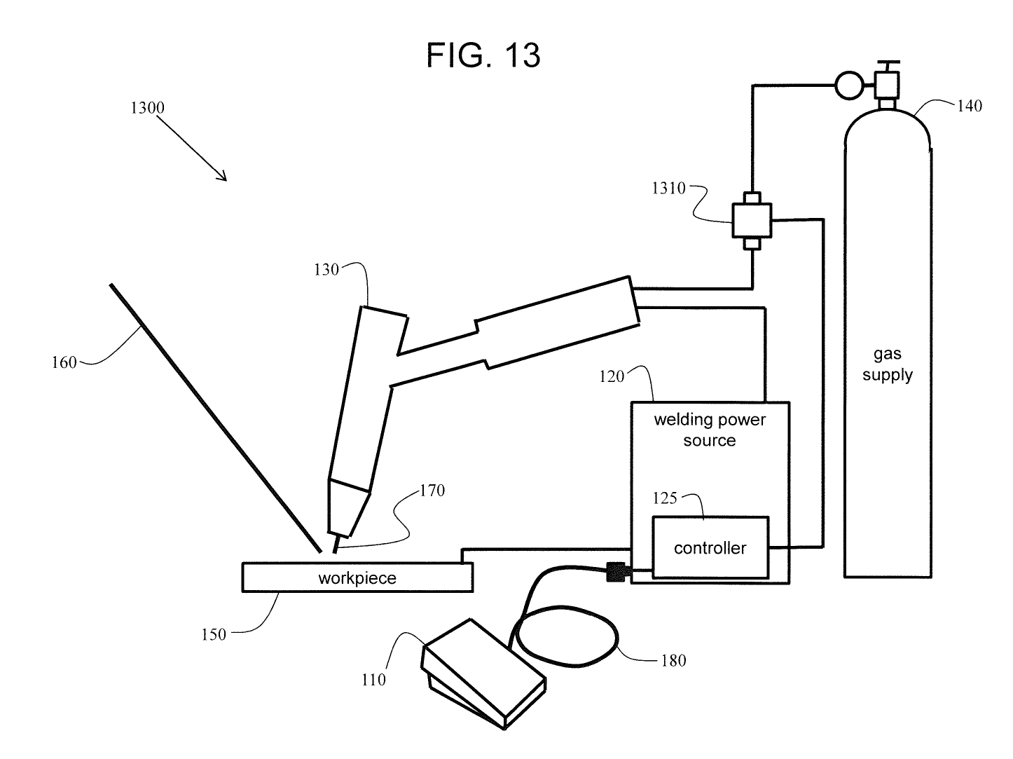

FIG. 13 illustrates a schematic diagram of a third exemplary embodiment of an arc welding system 1300 having an advanced controls foot pedal device, and providing pre-flow and post-flow shielding. In accordance with an embodiment, the system 1300 provides a pre-flow functionality, where shielding gas from the gas supply 140 is allowed to flow for a predetermined time before welding starts (i.e., a predetermined time before current is permitted to be output from the welding power source and establish an arc between the electrode 170 and the workpiece 150). Similarly, the system 1300 provides a post-flow functionality, where gas from the gas supply 140 is allowed to flow for a predetermined time after welding ends (i.e., a predetermined time after current from the welding power source is turned off and an arc between the electrode 170 and the workpiece 150 is extinguished).

Allowing gas to flow for a finite time (pre-flow/post-flow) in this manner helps ensure that the weld puddle initiates and solidifies in the presence of a proper shielding gas. In accordance with an embodiment, the controller 125 of the welding power source 120 is configured to drive an external solenoid-activated valve 1310 operatively connected between the gas supply 140 and the welding tool 130, in a timed manner with respect to providing the welding output current from the power source, to accomplish the pre-flow and post-flow functionality.

In accordance with an embodiment, the ACFP device may command a defined ramping down of current at the end of welding when an operator completely releases the foot pedal. This may be desirable for providing crater fill at the end of an aluminum welding process, for example. The ramping down segment may be pulsed or not, in accordance with various embodiments.

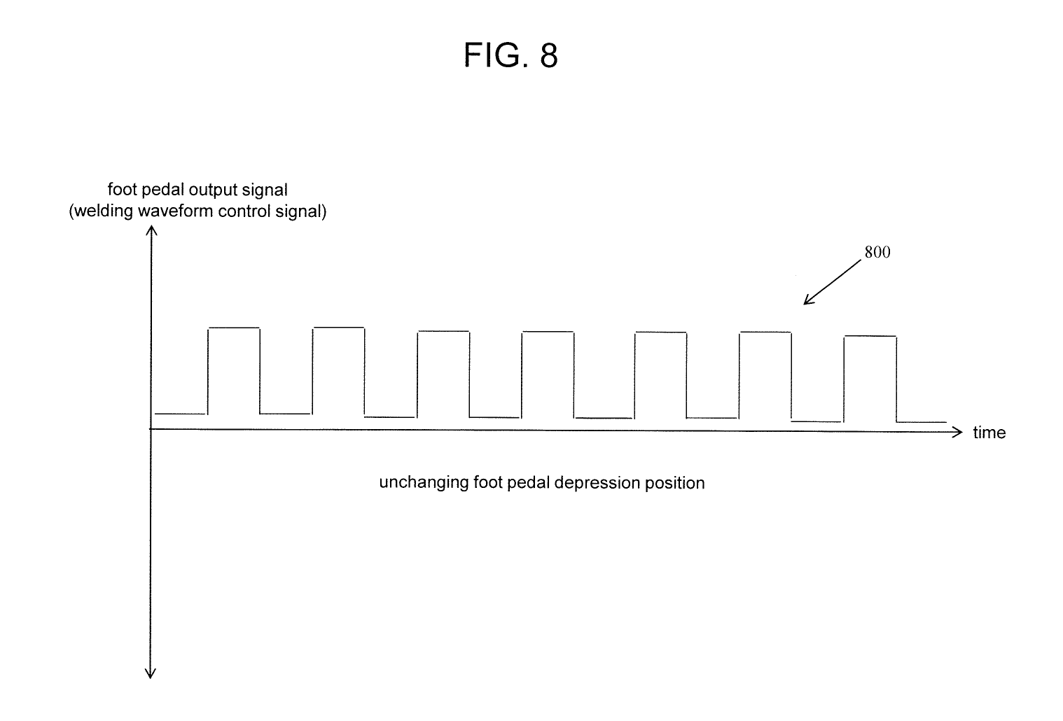

FIG. 8 illustrates a first exemplary embodiment of a foot pedal output signal (welding waveform control signal) 800 generated by the advanced controls foot pedal (ACFP) device 110 of FIG. 5 and FIG. 6 when a depressed pedal position of the ACFP device 110 is held constant over time during a first selected mode of operation. The welding waveform control signal 800 may be similar to the welding waveform control signal 320 of FIG. 3. When an operator holds the foot pedal 520 in a constant position, a square wave signal having a constant pulsed frequency and a constant peak pulsed output level is generated and output by the ACFP device 110 as the foot pedal output signal. Changing the depressed foot pedal position may change one or more waveform characteristics (e.g., the pulsed frequency or the peak pulsed output level) of the foot pedal output signal and, therefore, change one or more waveform characteristics (e.g., the pulsed frequency or the peak pulsed output current level) of the welding output waveform of the welding power source 120. The amount of change of the one or more waveform characteristics is dependent on the amount of change of the depressed foot pedal position.

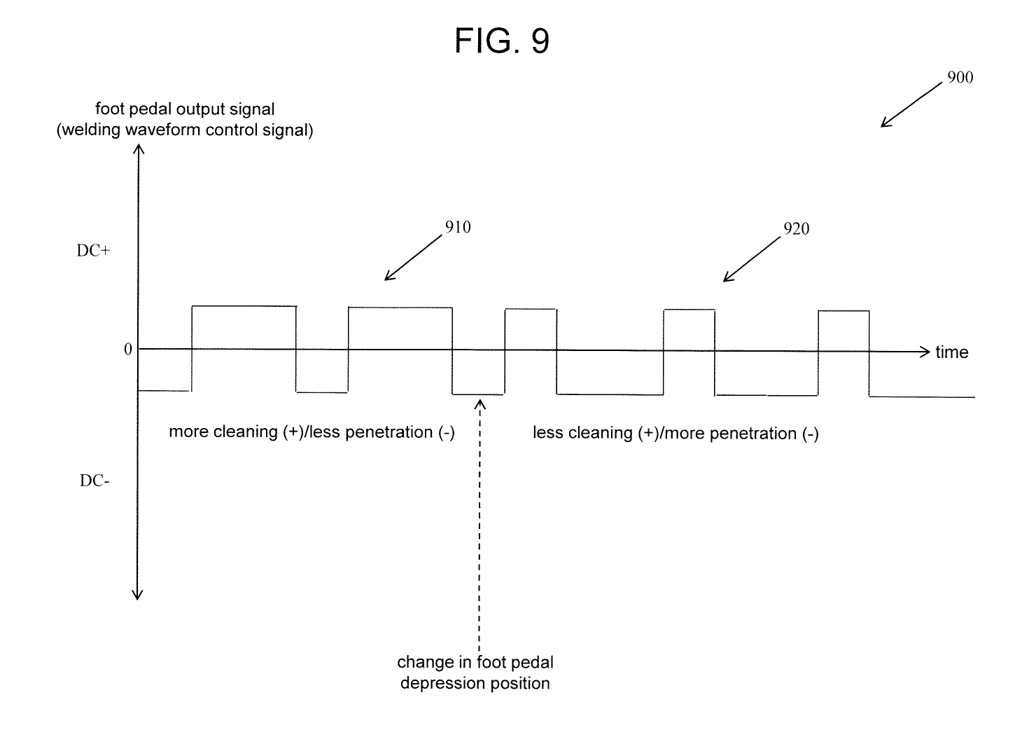

FIG. 9 illustrates a second exemplary embodiment of a foot pedal output signal (welding waveform control signal) 900 generated by the advanced controls foot pedal (ACFP) device 110 of FIG. 5 and FIG. 6 when a depressed pedal position of the ACFP device 110 is changed during a second selected mode of operation. It is known in the art of TIG welding that providing more DC+ welding output current (see waveform portion 910 of the waveform 900) provides for more cleaning action at the workpiece, and providing more DC− output current (see waveform portion 920 of the waveform 900) provides for more penetration into the workpiece. In the mode of operation shown in FIG. 9, changing the depressed foot pedal position changes the AC balance and, therefore, the amount of cleaning action (DC+) vs. the amount of penetration (DC−). In this manner, an operator can trade off between an amount of workpiece cleaning action and an amount of penetration during a TIG welding process. The amount of change between cleaning and penetration is dependent on the amount of change of the depressed foot pedal position.

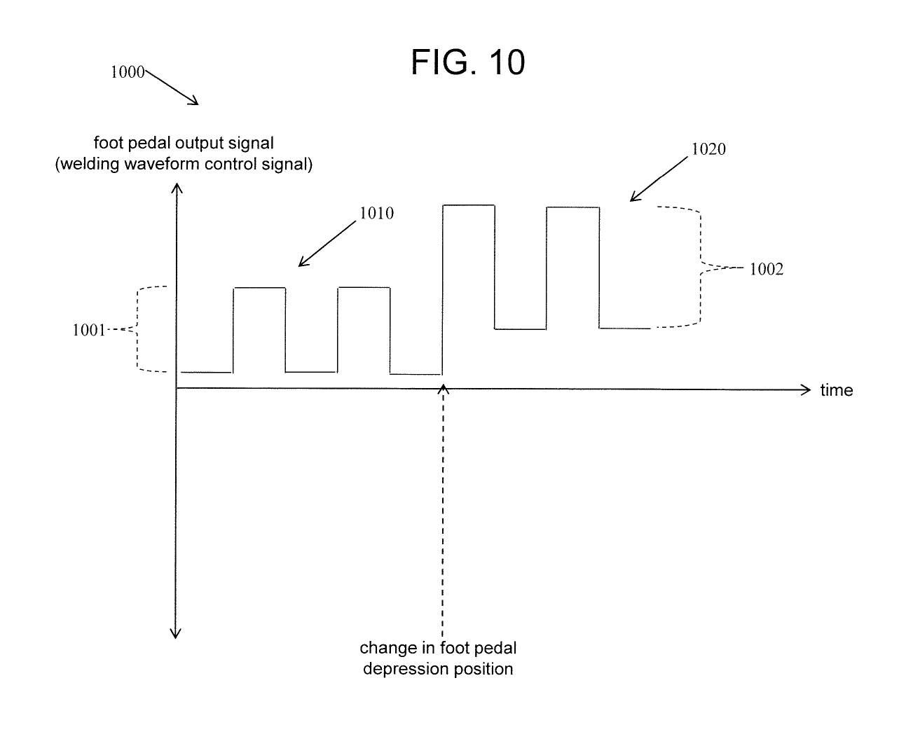

FIG. 10 illustrates a third exemplary embodiment of a foot pedal output signal (welding waveform control signal) 1000 generated by the advanced controls foot pedal (ACFP) 110 device of FIG. 5 and FIG. 6 when a depressed pedal position of the ACFP device 110 is changed during a third selected mode of operation. In the mode of operation shown in FIG. 10, changing the depressed foot pedal position effects a change from a first peak-to-background current range 1001 during a first portion 1010 of the pulsed welding waveform control signal 1000 to a second peak-to-background current range 1002 during a second portion 1020 of the pulsed welding waveform control signal 1000. Changing a peak-to-background current range in this manner may allow an operator to change, for example, an amount of heat input to a weld via the ACFP device 110. The amount of change in the peak-to-background current range is dependent on the amount of change of the depressed foot pedal position.

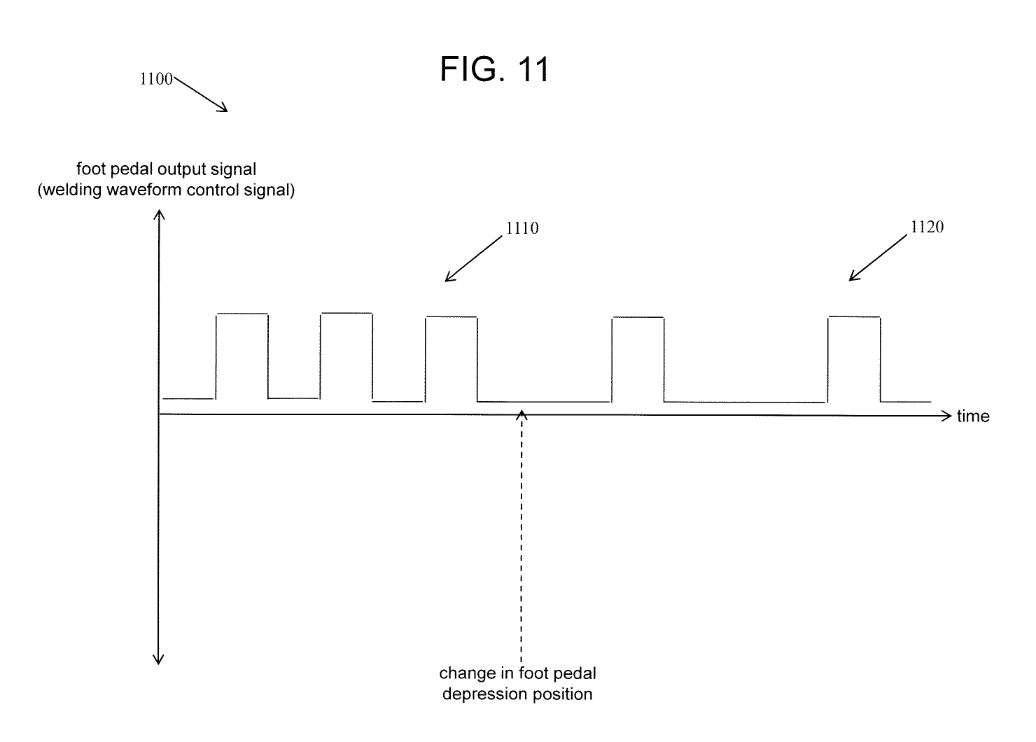

FIG. 11 illustrates a fourth exemplary embodiment of a foot pedal output signal (welding waveform control signal) 1100 generated by the advanced controls foot pedal (ACFP) device 110 of FIG. 5 and FIG. 6 when a depressed pedal position of the ACFP device 110 is changed during a fourth selected mode of operation. In the mode of operation shown in FIG. 11, changing the depressed foot pedal position effects a change from a first pulsed frequency during a first portion 1110 of the pulsed welding waveform control signal 1100 to a second pulsed frequency during a second portion 1120 of the pulsed welding waveform control signal 1100. Changing a pulsed frequency in this manner may allow an operator to change, for example, a weld bead “stacked dime” spacing via the ACFP device 110. The amount of change of the pulsed frequency is dependent on the amount of change of the depressed foot pedal position.

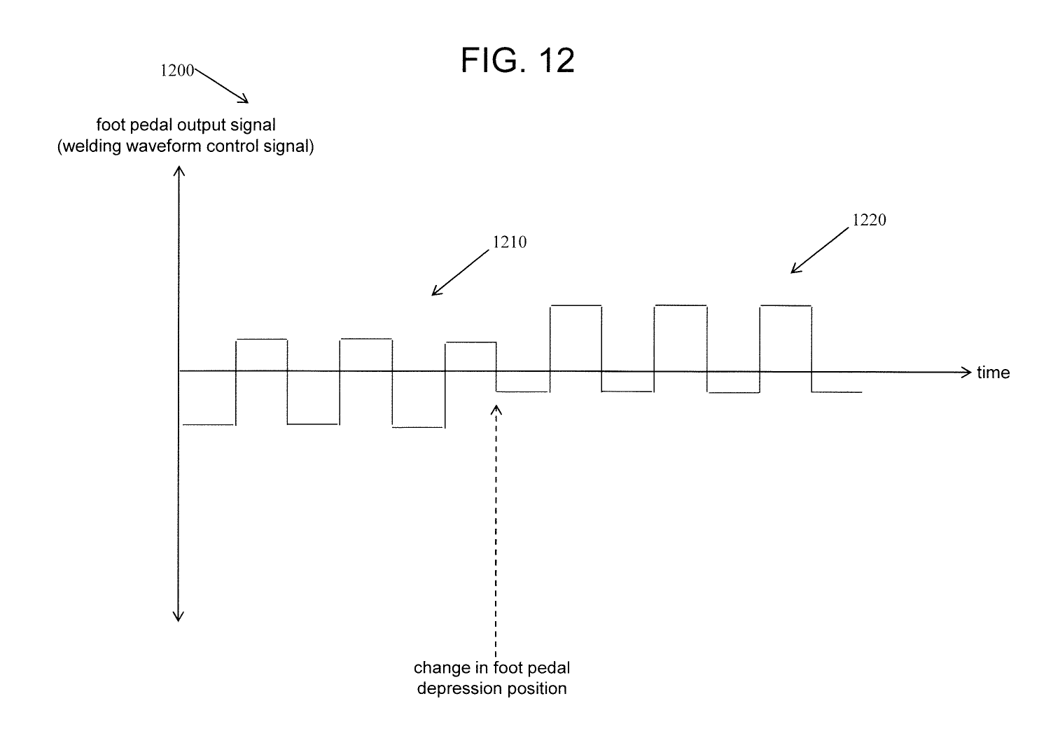

FIG. 12 illustrates a fifth exemplary embodiment of a foot pedal output signal (welding waveform control signal) 1200 generated by the advanced controls foot pedal (ACFP) device 110 of FIG. 5 and FIG. 6 when a depressed pedal position of the ACFP device is changed during a fifth selected mode of operation. In the mode of operation shown in FIG. 12, changing the depressed foot pedal position effects a change from a first AC offset during a first portion 1210 of the pulsed welding waveform control signal 1200 to a second AC offset during a second portion 1220 of the pulsed welding waveform control signal 1200. Changing an AC offset in this manner may allow an operator to trade off between penetration and deposition in a MIG welding process, for example. A more positive AC offset corresponds to increased penetration, and a more negative AC offset corresponds to more melt off and, therefore, to increased deposition. The amount of change of the AC offset is dependent on the amount of change of the depressed foot pedal position.

In accordance with various embodiments, other modes of operation may be provided by the ACFP device which allow control of other waveform characteristics or other combinations of waveform characteristics. The example embodiments of modes of operation provided herein are not meant to be exhaustive. The logic in the control circuitry 620 (whether hardware-implemented, software-implemented, or some combination thereof) determines the control of the waveform characteristics with foot pedal position.

In summary, systems, methods, and apparatus providing advanced controls in a foot pedal device used in arc welding are disclosed. The foot pedal device is configured to interface with a welding power source and provide one or more selectable modes of operation, allowing an operator to control one or more waveform characteristics of an output welding waveform. The advanced control logic for controlling the one or more waveform characteristics resides in the foot pedal device and is responsive to a depressed position of the foot pedal device. Such a foot pedal device, having advanced controls, allows for the advanced, real-time control of the output of a simple (low end) welding power source during a welding process.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. An advanced controls foot pedal device for use in arc welding, comprising:
a user depressible foot pedal;
control circuitry configured to generate a welding waveform control signal having one or more waveform characteristics that change with a depressed foot pedal position of the user depressible foot pedal; and
output interface circuitry operatively connected to the control circuitry and configured to provide a communication interface to a welding power source for transmitting the welding waveform control signal from the advanced controls foot pedal device to the welding power source,
wherein the welding waveform control signal is formulated to affect a welding output of the welding power source based on the one or more waveform characteristics.

2. The advanced controls foot pedal device of claim 1, wherein said one or more waveform characteristics includes one or more of a pulsed frequency, a peak pulsed output level, an AC balance, and AC offset, or a peak-to-background range.

3. The advanced controls foot pedal device of claim 1, further comprising a user interface configured to allow a user to select a mode of operation from a plurality of modes of operation, wherein a mode of operation defines how one or more waveform characteristics of the welding waveform control signal changes with depressed foot pedal position.

4. The advanced controls foot pedal device of claim 3, further comprising input interface circuitry operatively connected to the control circuitry and configured to receive input information from one or more of the depressible foot pedal or the user interface.

5. The advanced controls foot pedal device of claim 1, further comprising a digital communication port configured to provide communication between the advanced controls foot pedal device and a personal computing device.

6. The advanced controls foot pedal device of claim 5, further comprising input interface circuitry operatively connected to the control circuitry and configured to receive input information from the digital communication port.

7. The advanced controls foot pedal device of claim 1, wherein the output interface circuitry is configured to provide a wireless communication interface to the welding power source.

8. The advanced controls foot pedal device of claim 7, wherein the wireless communication interface is one of a radio frequency communication interface, an infrared communication interface, or an ultrasonic communication interface.

9. A system comprising:
a welding power source;
the advanced controls foot pedal device of claim 1 operatively interfacing to the welding power source; and
a welding tool operatively connected to the welding power source.

10. The system of claim 9, wherein a shape of a welding waveform current of the welding output of the welding power source directly follows a shape of the welding waveform control signal.

11. The system of claim 9, wherein a shape of a welding waveform voltage of the welding output of the welding power source directly follows a shape of the welding waveform control signal.

12. The system of claim 9, wherein the welding power source includes a controller configured to receive the welding waveform control signal from the advanced controls foot pedal device.

13. The system of claim 9, wherein the welding power source includes a wireless receiver configured to wirelessly receive the welding waveform control signal from the advanced controls foot pedal device.

14. The system of claim 9, wherein the advanced controls foot pedal device is configured to command a defined ramping down of a welding waveform current of the welding output of the welding power source via the welding waveform control signal when a user completely releases the user depressible foot pedal of the advanced controls foot pedal device.

15. A method comprising:
generating a welding waveform control signal, having one or more waveform characteristics, with a foot pedal device in response to activating the foot pedal device to a first depressed foot pedal position;
communicating the welding waveform control signal from the foot pedal device to a welding power source to affect a welding output of the welding power source based on the one or more waveform characteristics; and
changing at least one of the one or more waveform characteristics of the welding waveform control signal in response to activating the foot pedal device to a second depressed foot pedal position.

16. The method of claim 15, further comprising communicating the welding waveform control signal from the foot pedal device to the welding power source to affect the welding output of the welding power source based on the one or more changed waveform characteristics.

17. The method of claim 15, wherein said one or more waveform characteristics includes one or more of a pulsed frequency, a peak pulsed output level, an AC balance, and AC offset, or a peak-to-background range.

18. The method of claim 15, wherein the welding waveform control signal is communicated from the foot pedal device to the welding power source wirelessly.

19. The method of claim 15, further comprising providing a shielding gas pre-flow functionality, where shielding gas from a gas supply is allowed to flow for a predetermined time before the welding power source starts outputting the welding output to create an arc between an electrode and a workpiece operatively connected to the welding power source.

20. The method of claim 15, further comprising providing a shielding gas post- flow functionality, where shielding gas from a gas supply is allowed to flow for a predetermined time after the welding power source stops outputting the welding output to cause an arc to extinguish between an electrode and a workpiece operatively connected to the welding power source.
